(19) United States
(12) Patent Application Publication
(10) Pub. No.: US 2015/0026665 A1
(43) Pub. Date: Jan. 22, 2015

(54) AUTOMATED TEST ON APPLICATIONS OR WEBSITES IN MOBILE DEVICES

(71) Applicants: Stella Guizhen Chen, Shanghai (CN); Dongsheng Xie, Shanghai (CN)

(72) Inventors: Stella Guizhen Chen, Shanghai (CN); Dongsheng Xie, Shanghai (CN)

(73) Assignee: eBay Inc., San Jose, CA (US)

(21) Appl. No.: 13/944,668

(22) Filed: Jul. 17, 2013

(51) Int. Cl. G06F 11/36

(52) U.S. Cl. CPC G06F 11/3688
USPC 717/124

(57) ABSTRACT

A method and a system to test one or more applications respectfully installed in a plurality of devices at the same time are provided. The system may include a server, which is coupled to the devices and receives a test script configured to test an application of the devices. The devices may respectively include a plurality of agent modules on behalf of the server. The server may include a detector module to detect one or more operating systems used in the devices, an API, using one or more processors, to convert the test script into one or more test commands compatible to the operating systems, and a transmitter module to transmit the commands to the agent modules based on the detected one or more operating systems. The agent modules may be configured to respectively conduct tests on the application installed in the devices respectively using the commands.

### TECHNICAL FIELD

The present application relates generally to the technical field of the test on communication devices and, in one specific example, to the test on applications and/or websites used in mobile communication devices.

### BACKGROUND

Different kinds of communication devices are widely used today. An example challenge may exist in the test on different kinds of communication devices with the limited time and resources due to the diversity of them.

### BRIEF DESCRIPTION OF THE DRAWINGS

Some embodiments are illustrated by way of example and not limitation in the figures of the accompanying drawings in which:

FIG. 1 is a block diagram illustrating an example embodiment, in which a test system may be deployed to test multiple mobile devices.

FIG. 2 is a block diagram illustrating a framework used in the test system configured to test multiple mobile devices according to an example embodiment.

FIG. 3 is a diagram illustrating an example test report regarding the tests on applications installed in multiple mobile devices according to an example embodiment.

FIG. 4 is a flowchart illustrating an example method of testing multiple mobile devices according to an example embodiment.

FIG. 5 is a diagrammatic representation of a machine in an example form of a computer system within which a set of instructions, for causing the machine to perform any one or more of the methodologies discussed herein, may be executed.

### DETAILED DESCRIPTION

Example methods and systems to automatically test applications or websites in mobile communication devices are described. In the following description, for purposes of explanation, numerous specific details are set forth in order to provide a thorough understanding of example embodiments. It will be evident, however, to one skilled in the art that the present application may be practiced without these specific details.

Today, some mobile communication applications or websites are running in different kinds of mobile communication devices (e.g., mobile phones). These mobile devices may come with e.g., different screen sizes, different Operating System (OS) versions (e.g., Android 2.1, 2.2 . . . 5.0, and IOS 4.1, 5.1 . . . 6.1), and different brands (e.g., Samsung, HTC, Moto, Google, and Motorola). Therefore, an example challenge may exist for the people (e.g., the QA testers) to test the mobile applications or websites running in different mobile devices with limited time and labour due to the diversity of the mobile devices.

In this disclosure of the application, a method and a test system to automatically test multiple mobile devices (e.g., mobile phones) at the same time are provided. For example, the test system may include a server, which may be coupled to the multiple mobile devices and may receive at least one test case (or test script) that is configured to test at least one application (or a website) of the multiple mobile devices. Each mobile device of the multiple mobile devices may include an agent module (e.g., as a remote control client) to work on behalf of the server inside each mobile device.

The server may include a framework, which may include, for example, a detector module to detect one or more OS versions used in the multiple mobile devices, an Application Programming Interface (API), using one or more processors, to convert the at least one test case into one or more test commands that are compatible to the one or more OS versions used in the multiple mobile devices, and a transmitter module to transmit the one or more commands to the multiple agent modules based on the detected one or more OS versions used in the multiple mobile devices.

By using the framework installed in the server, a QA tester may write or obtain at least one test case (or test script) to test the at least one application (or website) that is installed in multiple mobile devices. Therefore, the at least one test case may be run on the multiple mobile devices automatically at the same time. After testing, a test report and one or more screen shots for each operation may be automatically created by the test system.

### Architecture

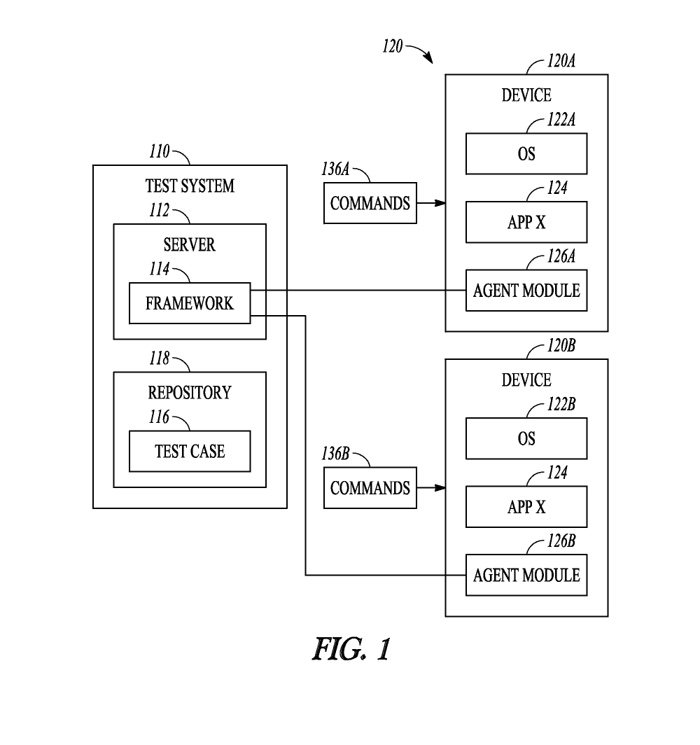

FIG. 1 is a block diagram illustrating an environment, within which a test system 110 may be deployed to test multiple mobile devices 120.

The test system 110 may be coupled to multiple mobile devices 120 (e.g., mobile phone 120A and mobile phone 120B) via connection lines 130 (e.g., cables 130A and 130B) for example. Alternatively, the test system 110 may be wirelessly coupled to the multiple mobile devices 120 (e.g., mobile phone 120A and mobile phone 120B) via a wireless network (e.g., the Internet, not shown in FIG. 1). The test system 110 may include a server 112. In some embodiments, the server 112 may include a framework 114. The framework 104 may be either a software module or a hardware-implemented module. The framework 114 may be configured to receive at least one test case (or test script) 116 in order to test at least one application (e.g., application X 124) installed in the multiple mobile devices 120. The at least one test case 116 may be either retrieved from a repository 118 accessible to the framework 114 or input by a QA tester.

The multiple mobile devices 120 (e.g., mobile phones 120A and 120B) may use operating systems 122 (e.g., 122A and 122B) of different versions (e.g., Android 4.1 and IOS 5.1). The multiple mobile devices 120 (e.g., 120A and 120B) may respectively include some applications 124 (e.g., applications 1, 2, 3 . . . X) that need to be tested. Each mobile device 120 (e.g., 120A) may include an agent module 126 (e.g., 126A) installed in this mobile device 120. During the test, each agent module (e.g., 126A) may work inside the mobile device (e.g., 120A) in which it is installed, on behalf of the server 112, to perform functions that are related to the tests on the mobile device (e.g., 120A). Therefore, the at least one test 116 may be automatically run on the multiple mobile devices 120 at the same time.

Example test cases such as test case 1 and test case 2 are illustrated below. Test case 1 is configured to test an application “TestSuite” installed in the multiple mobile devices 120 for example. Test case 2 is configured to test an application “testSearchAd” installed in the multiple mobile devices 120 for example.

Test Case 1:

Public Static TestSuite( ) {

TestSetup setup = new TestSetup(new TestSuite(LoginTest.class)) {

protected void eard( ) throws Exception {

// Typical setup( )
pkm = new RemotePkm(SplashScreenActivity.class);
// emulators
pkm.addDevice(“emulator-5554”, 5004, 5004);
pkm.addDevice(“emulator-5556”, 5003, 5003);
// HTC A8181
pkm.addDevice(“HT9CSP819063”, 5005, 5005);
// Samsung T959
pkm.addDevice(“T959fb596457”, 5002, 5002);
pkm.connect( );

```
  }
  protected void eardown( ) throws Exception {
```

pkm.disconnect( );

}

}

}

Test Case 2:

public void testSearchAd( ) throws Exception {

// click on search tab
pkm.sleep(3000);
pkm.clickOnText(“Suche”);
// assert element on search tab
assertTrue(pkm.searchText(“Was?”));
assertTrue(pkm.searchText(“Ort”));
assertTrue(pkm.searchText(“Kategorie”));
// enter keyword
String keyword = “BMW”;
pkm.enterText(0,keyword);
pkm.sleep(5000);
pkm.clickOnText(“Ort”);
// click on OK button
pkm.clickOnButton(“Fertig”);
// click 10km
pkm.clickInList(1);
// clickOnText(“10 km”);
pkm.sleep(5000);
pkm.clickOnButton(“Suche”);
pkm.sleep(10000);
assertTrue(pkm.searchText(“Anpassen”));

}

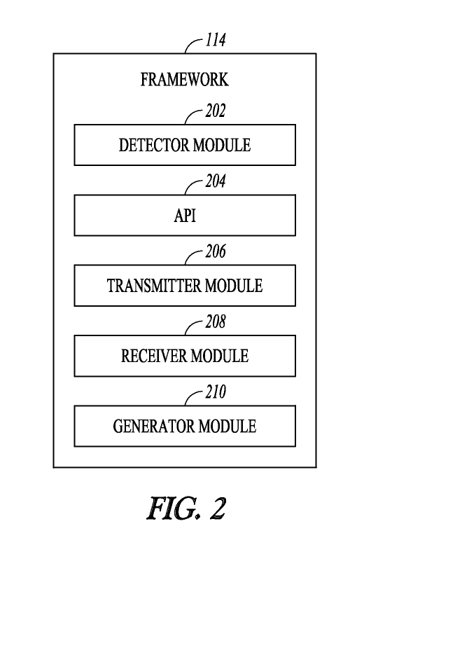

FIG. 2 is a block diagram illustrating the framework 114 used in the system 110 according to an example embodiment. For example, the framework 114 may be included in the server 112 of the test system 110. The framework 114 may include a detector module 202, an Application Programming Interface (API) 204, a transmitter module 206, a receiver module 208, a generator module 210. In order to test one or more applications (e.g., an application X 124) respectfully installed in the multiple mobile devices 120 for example, at least one test case 116 may be used. The at least one test case 116 may be drafted by a person (e.g., a QA tester), and may be retrieved from a repository 118, which can be inside or outside the test system 110.

In the disclosure of the application, modules (such as the detector module 202, the API 204, the transmitter module 206, the receiver module 208, and the generator module 210) may constitute either software modules (e.g., code embodied (1) on a non-transitory machine-readable medium or (2) in hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

In some embodiments, the detector module 202 may detect one or more operating systems 122 used in the multiple devices 120. For example, the detector module 202 in the framework 114 of the test system 110 may detect and find, using an agent module 126A installed in a mobile device 120A (e.g., a mobile phone), on behalf of the server 112, the version (e.g., Android 4.1) of the operating system 122A used in the mobile device 120A. The detector module 202 in the framework 114 of the test system 110 may also detect and find, by an agent module 126B installed in another mobile device 120B (e.g., a mobile phone), on behalf of the server 112, the version (e.g., IOS 5.1) of the operating system 122B used in the mobile device 120B.

In some embodiments, the API 204 may, using one or more processors, based on the detection of the operating systems 122 by the detector module 202, convert the at least one test case 116 (e.g., Test Case 1 as previously shown) into one or more test commands (e.g., 136A and 136B) compatible to the one or more operating systems 122 (e.g., operating systems 122A and 122B) that are used in the multiple mobile devices 120 (e.g., mobile phones 120A and 120B).

In some embodiments, the transmitter module 206 may transmit the one or more commands (e.g., 136A and 136B) respectively to the multiple agent modules (e.g., 126A and 126B) based on the multiple operating systems (e.g., 122A and 122B) used in the multiple mobile devices (e.g., 120A and 120B). For example, the one or more commends 136A, compatible to the OS 122A (e.g., Android 4.1) used in the mobile device 120A, are transmitted by the transmitter module 206 to the agent module 126A installed in the mobile device 120A. In another example, the one or more commends 136B, compatible to the OS 122B (e.g., e.g., IOS 5.1) used in the mobile device 120B, are transmitted by the transmitter module 206 to the agent module 126B installed in the mobile device 120B.

On the side of the multiple mobile devices 120, the multiple agent modules 126 (e.g., 126A and 126B) installed in the multiple mobile devices 120 (e.g., 120A and 120B) may respectively receive the one or more commands 136 (e.g., 136A and 136B). The multiple agent modules 126 (e.g., 126A and 126B) may then respectively perform, on behalf of the server 112 of the test system 110, functions related to tests on the one or more applications (e.g., application X 124) respectively installed in the multiple mobile devices 120 (e.g., 120A and 120B).

Upon finishing the tests on the one or more applications (e.g., the application X 124) respectively installed in the multiple mobile devices 120 (e.g., 120A and 120B), the multiple agent modules 126 (e.g., 126A and 126B) may respectively retrieve or obtain test results regarding the one or more applications respectively installed in the multiple devices 120 (e.g., 120A and 120B). Then, multiple agent modules 126 (e.g., 126A and 126B) may respectively send the test results to the framework 114 of the test system 110.

In some embodiments, the receiver module 208 of the framework 114 may receive the test results respectively from the multiple agent modules 126 (e.g., 126A and 126B). The rest results regarding the one or more applications installed in a specific mobile device 120 (e.g., 120A) may indicate whether the tests on the one or more applications installed in the specific mobile device fail or pass.

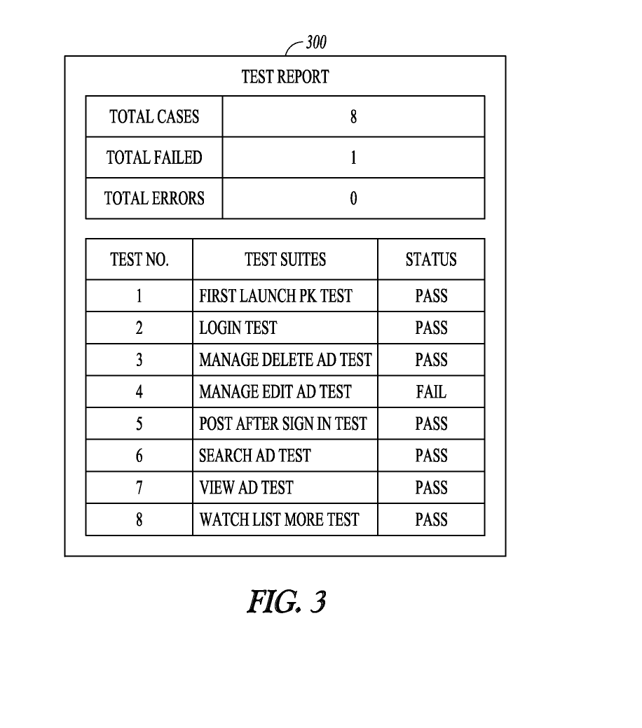

FIG. 3 is a diagram illustrating an example test report 300 regarding the tests on one or more applications installed in a mobile device 120 according to an example embodiment.

In some embodiments, the generator module 210 of the framework 114 may generate a test report regarding the one or more applications of the mobile device 120 under test, using the test results on the one or more applications of the mobile device 120 (e.g., 120A). As shown in FIG. 3, the test report 300 indicates that eight tests have been conducted on eight applications (e.g., FirstLaunchPKTest, LoginTest, ManageDeleteAdTest, ManageEditAdTest, SearchAdTest, ViewAdTest, and WatchListMoreTest) that are installed in a mobile device (e.g., 120A), one test on an application (e.g., ManageEditAdTest) fails while seven tests on other applications pass, and no errors are found during the tests.

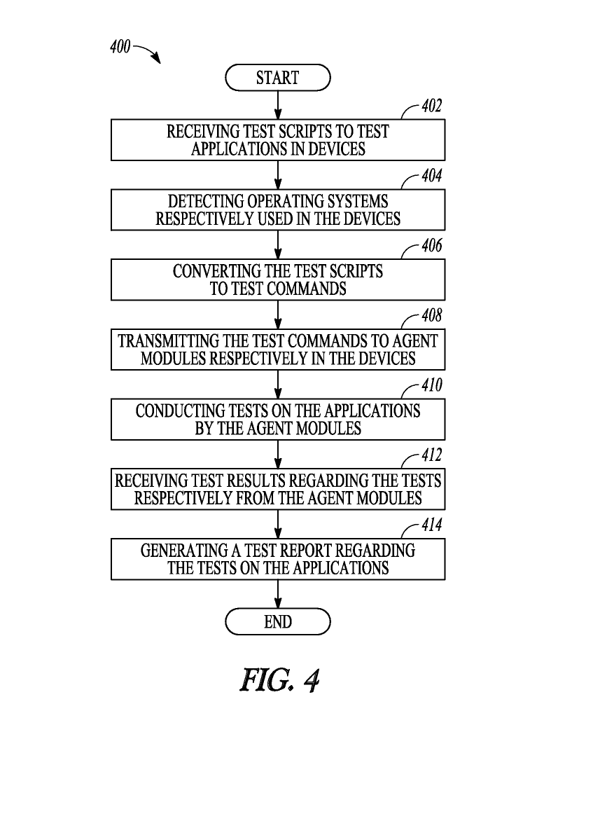

FIG. 4 is a flowchart illustrating an example method 400 of testing one or more applications (e.g., application X 124) installed in the multiple mobile devices 120 (e.g., 120A and 120 B) according to an example embodiment.

At 402, one or more test cases 116 may be received at a server 112 to test one or more applications (e.g., FirstLaunchPKTest, LoginTest, ManageDeleteAdTest, ManageEditAdTest, PostAfterSignlnTest, SearchAdTest, ViewAdTest, and WatchListMoreTest, as shown in FIG. 3) respectively installed in multiple mobile devices 120. The multiple mobile devices 120 (e.g., 120A and 120B) may include multiple agent modules 126 (e.g., 126A and 126B) each installed in the multiple mobile devices 120. In some embodiments, the one or more test cases 116 may be input by a QA tester. In other embodiments, the one or more test cases 116 may be retrieved from a memory (e.g., repository 118). The repository 118 may be inside or outside the test system 110.

At 404, a detector module 202 of the server 112 may detect one or more operating systems 122 respectively used in the multiple mobile devices 120. For example, the mobile devices 120A and 120B may respectively use operating system 122A (e.g., Android 4.1) and operating system 122B (e.g., IOS 5.1).

At 406, an Application Programming Interface (API) 204 of the server 112 may, using one or more processors, convert the one or more test cases 116 into one or more test commands 136 (e.g., 136A and 136B) compatible to the one or more operating systems 122 (e.g., 122A and 122B) respectively used in the multiple mobile devices 120 (e.g., 120A and 120B). In one example, based on the detection of the operating systems 122A and 122B used in the multiple mobile devices 120A and 120B, the API 204 may convert the one or more test cases 116 into test commands 136A that are compatible to the operating system 122A (e.g., Android 4.1) used in the mobile device 120A. In another example, the API 204 may convert the one or more test cases 116 into test commands 136B that are compatible to the operating system 122B (e.g., IOS 5.1) used in the mobile device 120B.

At 408, a transmitter module 206 of the server 114 may transmit, via the connection lines 130 (e.g., 130A and 130B), the one or more commands 136 (e.g., 136A and 136B) respectively to the multiple agent modules 126 (e.g., 126A and 126B) based on the one or more detected operating systems 122 (e.g., 122A and 122B).

At 410, after respectively receiving the one or more commands 136 (e.g., 136A and 136B) from the transmitter module 206 of the server 114, the multiple agent modules 126 (e.g., 126A and 126B) may respectively conduct tests on the one or more applications (e.g., FirstLaunchPKTest, LoginTest, ManageDeleteAdTest, ManageEditAdTest, PostAfterSignlnTest, SearchAdTest, ViewAdTest, and WatchListMoreTest, as shown in FIG. 3) installed in the multiple mobile devices (e.g., 120A and 120B). In some embodiments, inside the multiple mobile devices (e.g., 120A and 120B), the multiple agent modules (e.g., 120A and 120B) are configured to obtain test results regarding the one or more applications respectively from the multiple mobile devices (e.g., 120A and 120B) on behalf of the server 112.

At 412, a receiver module 208 of the framework 114, on the server side, may receive the test results regarding the one or more applications installed in the multiple mobile devices 120 (e.g., 120A and 120B) from the multiple agent modules 126 (e.g., 126A and 126B). In some embodiments, the test results may inform whether the one or more commands are successful on the corresponding multiple mobile devices 120. In some embodiments, the test results may include multiple screen shots of the multiple mobile devices.

At 414, a report generator module 210 of the framework 114 may generate a test report (e.g., the test report 300 as shown in FIG. 3) regarding the one or more applications (e.g., application X 124) installed in the multiple mobile devices 120 (e.g., 120A and 120B) based on the one and more test cases 116 and the test results.

### EXAMPLE MACHINE ARCHITECTURE AND MACHINE-READABLE MEDIUM

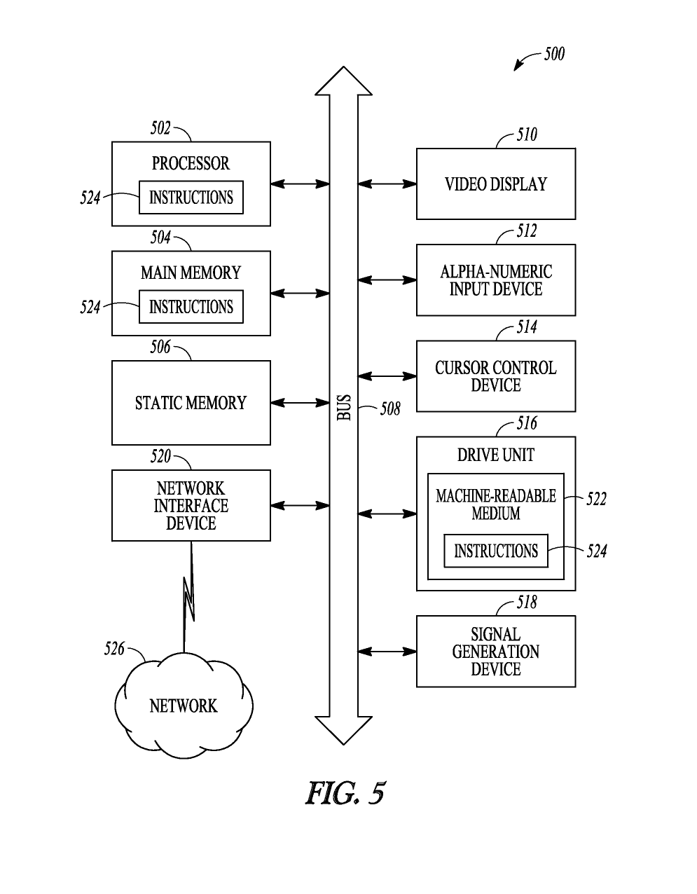

FIG. 5 is a diagrammatic representation of a machine in an example form of a computer system within which a set of instructions, for causing the machine to perform any one or more of the methodologies discussed herein, may be executed.

In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU) a graphics processing unit (GPU) or both), a main memory 504 and a static memory 506, which communicate with each other via a bus 508. The computer system 500 may further include a video display unit 510 (e.g., a liquid crystal display (LCD) or a cathode ray tube (CRT)). The computer system 500 also includes an alphanumeric input device 512 (e.g., a keyboard), a cursor control device 514 (e.g., a mouse), a disk drive unit 516, a signal generation device 518 (e.g., a speaker) and a network interface device 520.

The disk drive unit 516 includes a machine-readable medium 522 on which is stored one or more sets of instructions (e.g., software 524) embodying any one or more of the methodologies or functions described herein. The software 524 may also reside, completely or at least partially, within the main memory 504 and/or within the processor 502 during execution thereof by the computer system 500, the main memory 504 and the processor 502 also constituting machine-readable media.

The software 524 may further be transmitted or received over a network 526 via the network interface device 520.

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system to test a plurality of devices at the same time have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A method comprising:
receiving, at a server, a test script to test an application installed in a plurality of devices, the plurality of devices including a plurality of agent modules each installed therein;
detecting, by a detector module of the server, one or more operating systems respectively used in the plurality of devices;
converting, by an Application Programming Interface (API) of the server, using one or more processors, the test script into one or more test commands compatible to the one or more operating systems; and
transmitting, by a transmitter module of the server, the one or more commands to the plurality of agent modules respectively based on the one or more operating systems.

2. The method of claim 1, wherein the plurality of agent modules are configured to respectively conduct tests on the application installed in the plurality of devices respectively using the one or more commands.

3. The method of claim 1, wherein the plurality of agent modules are configured to obtain test results respectively from the plurality of devices on behalf of the server.

4. The method of claim 3, further comprising:
receiving, by a receiver module of the server, the test results respectively from the plurality of agent modules.

5. The method of claim 4, further comprising:
generating, by a generator module of the server, a test report regarding the application installed in the plurality of devices based on the test script and the test results.

6. The method of claim 4, wherein the test results inform whether the one or more commands are successful on the corresponding plurality of devices.

7. The method of claim 4, wherein the test results include a plurality of screen shots of the plurality of devices.

8. The method of claim 1, wherein the one or more operating systems include Android and IOS.

9. A system of testing a plurality of devices, comprising:
a server to receive a test script configured to test an application of the plurality of devices, the server being coupled to the plurality of devices, the server comprising:
a detector module to detect one or more operating systems used in the plurality of devices, the plurality of devices including a plurality of agent modules on behalf of the server;
an Application Programming Interface (API), using one or more processors, to convert the test script into one or more test commands compatible to the one or more operating systems; and
a transmitter module to transmit the one or more commands to the plurality of agent modules based on the one or more operating systems.

10. The system of claim 9, wherein the plurality of agent modules are configured to respectively conduct tests on the application installed in the plurality of devices respectively using the one or more commands.

11. The system of claim 9, wherein the plurality of agent modules are configured to obtain test results respectively from the plurality of devices on behalf of the server.

12. The system of claim 9, wherein the server further comprising:
a receiver module to receive the test results from the plurality of agent modules.

13. The system of claim 12, wherein the server further comprising:
a generator module to generate a test report regarding the application of the plurality of devices based on the test script and the test results.

14. The system of claim 9, wherein the server is coupled to the plurality of devices via a plurality of channels.

15. The system of claim 9, wherein the server is wirelessly coupled to the plurality of devices via a network.

16. The system of claim 9, wherein the one or more operating systems include Android and IOS.

17. A non-transitory machine-readable medium having instructions embodied thereon, the instructions executable by one or more machines to perform operations comprising:
receiving, at a server, a test script to test an application installed in a plurality of devices, the plurality of devices including a plurality of agent modules each installed therein;
detecting, by a detector module of the server, one or more operating systems respectively used in the plurality of devices;
converting, by an Application Programming Interface (API) of the server, using one or more processors, the test script into one or more test commands compatible to the one or more operating systems; and
transmitting, by a transmitter module of the server, the one or more commands to the plurality of agent modules respectively based on the one or more operating systems, the plurality of agent modules being configured to obtain test results respectively from the plurality of devices on behalf of the server.

18. The non-transitory machine-readable medium of claim 17, the operations further comprising:
receiving, by a receiver module of the server, the test results respectively from the plurality of agent modules.

19. The non-transitory machine-readable medium of claim 18, the operations further comprising:
generating, by a generator module of the server, a test report regarding the application installed in the plurality of devices based on the test script and the test results.

20. The non-transitory machine-readable medium of claim 1, wherein the plurality of agent modules are configured to respectively conduct tests on the application installed in the plurality of devices respectively using the one or more commands.
